(19) United States
(12) Patent Application Publication
(10) Pub. No.: US 2026/0024465 A1
(43) Pub. Date: Jan. 22, 2026

(54) SYSTEM AND METHOD FOR CONTROLLING A BEATING HEART SURGICAL TRAINING TOOL

(71) Applicant: AtriCure, Inc., Mason, OH (US)

(72) Inventor: Jackson Thomas Romelli, Cincinnati, OH (US)

(21) Appl. No.: 19/276,380

(22) Filed: Jul. 22, 2025

Related U.S. Application Data
(60) Provisional application No. 63/673,831, filed on Jul. 22, 2024.

(51) Int. Cl. G09B 23/30

(52) U.S. Cl. CPC G09B 23/30

(57) ABSTRACT

Provided is a system and methods of controlling heart animation of a training model in a sinus or arrhythmic beating pattern based on at least one input parameter. The method may include selectively controlling an adjustable valve in phases according to the at least one input parameter to animate the heart. Additionally, the method may include adjusting input parameters during operation based on an environmental stimulus.

### RELATED APPLICATION

This application is a U.S. Nonprovisional Patent application claiming priority to U.S. Provisional Patent Application No. 63/673,831, filed Jul. 22, 2024, the entirety of which is incorporated by reference herein.

### TECHNICAL FIELD

This invention relates to devices and methods of controlling the animation of a heart in a real or synthetic cadaver for accurate simulation of the cardiac space for the purpose of training and education of cardiac surgery professionals.

### BACKGROUND

As medical technology advances there is a need for physicians to practice new surgical techniques using novel treatments as well as practice existing surgical skills using novel devices. There is a clear benefit to patients if a physician can train on an accurate model when preparing for an unfamiliar surgical procedure or when using an unfamiliar device. The need for such training is even more critical when the operative field includes a target organ that undergoes cyclic motion during the surgical procedure.

Cardiac surgery is one specific area that can benefit from an accurate training model. Traditionally, physicians would arrest the heart to cease or slow motion of the cardiac tissue. In order to avoid the complications that can be associated with arresting heart motion, many cardiac procedures involve beating heart surgery where the physician performs the procedure while the cardiac tissue moves through a cyclic rhythm indicative of regular cardiac function. In the field of beating heart surgery, it is known to use a prosthetic model of a beating heart to simulate clinical situations of beating heart surgery for training. A prosthetic heart model attempts to duplicate the exposure and feel of a beating heart during surgery and allows both the surgeon-in-training as well as the veteran surgeon the opportunity to develop skills needed for consistent results when performing cardiac surgery on the non-arrested heart.

Existing training models are disclosed in U.S. Pat. No. 6,685,481 to Chamberlain: U.S. Pat. No. 7,798,815 to Ramphal, et al., and U.S. Pat. No. 8,834,172 to Rubinstein, et al., the entirety of each of which is incorporated by reference. However, these approaches either rely on: (a) an artificial heart model specifically fabricated for the procedure (e.g., U.S. Pat. No. 6,685,481 to Chamberlain); (b) animal organs to simulate human organs and positioning the non-human tissue within a mock chest cavity (e.g., U.S. Pat. No. 7,798,815 to Ramphal, et al.); or (c) rely on a simulated model where a tissue-equivalent material includes an array of electrodes to form an artificial heart on which the simulated procedure is to be performed (e.g., U.S. Pat. No. 8,834,172 to Rubinstein et al.). An additional training model is disclosed in U.S. Pat. No. 11,062,626 to McHale, the entirety of which is incorporated by reference, however this model does not disclose an advanced system or method by which it is controlled to produce sufficiently realistic heart rhythms.

A limitation of such artificial training models is that the control of heart animation can result in a less than ideal training environment. For instance, the anatomy of many patients requiring cardiac surgery can vary greatly and be less than ideal due to the patient's age, obesity, scar tissue, as well as a variety of other conditions that affect individuals. U.S. Pat. No. 11,062,626 to McHale addresses this problem by providing a training model able to animate a cadaver heart as well as a synthetic heart. However, it does not disclose a means or method of controlling the system in a way that would produce realistic heart motions and/or responses.

The present disclosure provides an improved system and method of controlling devices to animate a cadaver or anatomically synthetic heart to produce sufficiently realistic cyclic motion.

### SUMMARY OF THE INVENTION

The present invention provides a system and methods of controlling heart animation of a training model in a sinus or arrhythmic beating pattern based on at least one input parameter. A controller may selectively control an adjustable valve in phases according to the at least one input parameter to animate the heart. Additionally, the controller may adjust input parameters during operation based on an environmental stimulus. For example, upon completion of a training procedure, the controller may adjust the control of the adjustable valve to go from an arrhythmia to a healthy sinus pattern.

In one variation, the environmental stimulus may be an input from an environmental sensor. The environmental sensor may be capable of registering when a procedure has been performed to reactively modify its control of the adjustable valve. In another variation the environmental stimulus is an input from a user to the control panel. In another variation the environmental stimulus is an input from a remote input means or device connected to the controller.

The controller generally controls animation of the heart in a training model according to the at least one input parameters by cycling through multiple control sequences. The multiple control sequences comprising an atrial inflation sequence, a ventricular inflation/atrial deflation sequence and a deflate sequence. The cycling of these sequences is synchronized according to a beat per minute (BPM) timer. After each cycle, the controller checks if a change event has occurred based on an environmental stimulus. If the change event has occurred, the controller will reactively adjust the at least one input parameter before performing the next cycle of the sequences. If no change event has occurred, the controller repeats the cycle of sequences according to the same input parameter used in the control of the prior cycle.

### BRIEF DESCRIPTION OF THE DRAWINGS

Like reference numerals are used to indicate like parts throughout the various drawing figures, wherein:

FIG. 1 is a view of the system being controlled by the controller.

FIG. 2 is a schematic view of an embodiment of the adjustable valve.

FIG. 3 is a flow diagram of the method used for controlling the system.

FIGS. 4A and 4B are a flow diagrams of the atrial inflation sequence for different rhythms.

FIGS. 5A and 5B are a flow diagram of the ventricular inflation sequence for different rhythms.

FIG. 6 is a schematic diagram of deflate sequence for all rhythms.

### DETAILED DESCRIPTION

With reference to the drawing figures, this section describes particular embodiments and their detailed construction and operation. Throughout the specification, reference to “one embodiment,” “an embodiment,” or “some embodiments” means that a particular described feature, structure, or characteristic may be included in at least one embodiment. Thus, appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments.

Methods and devices described herein provide for controlling a training model of an animated heart typically in a cadaver. The present disclosure incorporates methods and devices disclosed in U.S. Pat. No. 11,062,626 to improve realism of the resulting cyclic motion of an animated heart in a sinus or arrhythmic beating pattern.

Specifically, the present disclosure incorporates and improves on the system of U.S. Pat. No. 11,062,626 having a plurality of tubes, each of the plurality of tubes being flexible to permit navigation through tortuous anatomy and having an expandable member coupled to a distal portion and a connector at a proximal portion, each of the plurality of tubes optionally includes at least one reinforcing member detachably coupled thereto, where the reinforcing member permits navigation of the plurality of tubes through a vascular lumen that is fluidly coupled to the heart to permit positioning of the expandable member in a chamber of the heart; a valve assembly configured to be coupled to a pressure source, the valve assembly having a plurality of ports; a controller coupled to the valve assembly and configured to operate the valve assembly to selectively control flow from the pressure source to the plurality of ports to create a plurality of fluid paths between the pressure source and each of the plurality of ports, such that the plurality of fluid paths are able to pressurize the expandable members when placed within the heart to reproduce the beating pattern.

Furthermore, the present disclosure incorporates the method of preparing a training model of an animated heart in U.S. Pat. No. 11,062,626. The method of preparing the training model being advancing a first catheter having a first expandable member into the cadaver; advancing a second catheter having a second expandable member into the cadaver; positioning the first expandable member into a first ventricle of the cadaver heart; positioning the second expandable member into a second ventricle of the cadaver heart; coupling the first catheter to a first fluid path, the first fluid path being in fluid communication with a positive pressure source via an adjustable valve; coupling the second catheter to the first fluid path; and monitoring a parameter of the fluid flow in the first catheter and the second catheter to control the fluid flow in the first fluid path via the adjustable valve to pressurize and depressurize the first expandable member and the second expandable member to produce a beating pattern in the cadaver heart.

Advancing a third catheter having a third expandable member into the cadaver; advancing a fourth catheter having a fourth expandable member into the cadaver; positioning the third expandable member into a first atrium of the cadaver heart; positioning the fourth expandable member into a second atrium; coupling the third catheter to a second fluid path, the second fluid path being in fluid communication with a positive pressure source via the adjustable valve; coupling the fourth catheter to the second fluid path; and monitoring a parameter of the fluid flow in the third catheter and the fourth catheter to control the fluid flow in the first fluid path via the adjustable valve to pressurize and depressurize the third expandable member and the fourth expandable member to produce a beating pattern in the cadaver heart.

The present invention provides a system and methods for controlling heart animation of the training model (synthetic or cadaver) to improve realism of the resulting cyclic motion of an animated heart in a sinus or arrhythmic beating pattern. It can be controlled in either a sinus or arrhythmic pattern by selectively controlling an adjustable valve based on an input parameter.

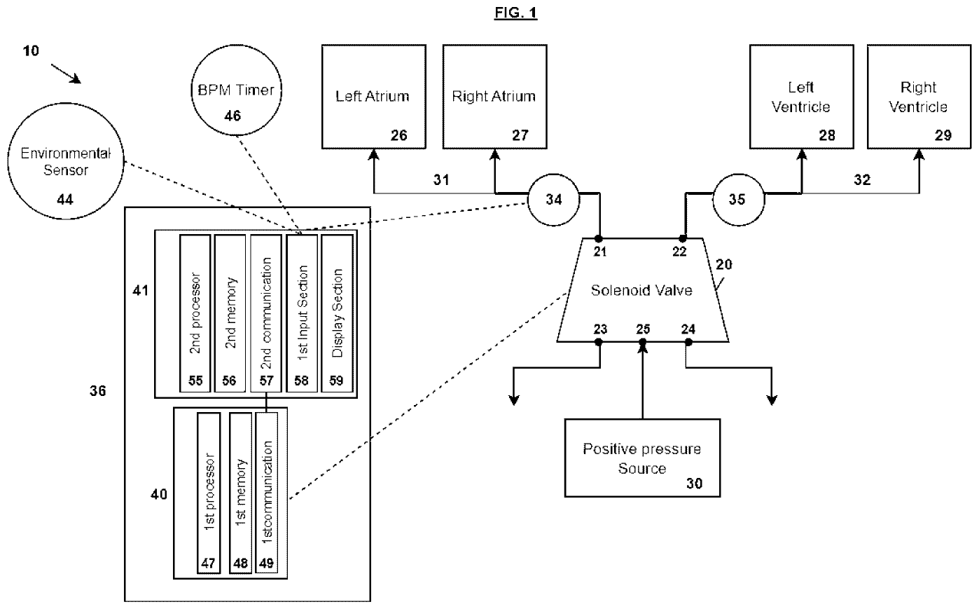

FIG. 1 schematically illustrates a system 10 having an adjustable valve 20 in connection with a positive pressure source 30. The positive pressure source 30 may be produced by CO₂, other compressed fluid (gas or liquid), or a motor.

The adjustable valve 20 having at least five ports: outlets 21, 22, exhausts 23, 24, and inlet 25. The outlet 21 for connecting the inflatable members in the atria 26, 27 to the adjustable valve 20 and outlet 22 for connecting the inflatable members in the ventricles 28, 29. The exhaust 23 for deflation of the inflatable members in the atria 26, 27, and exhaust 24 for deflation of the inflatable members in the ventricles 28, 29. The inlet 25 for connection of the positive pressure source 30 to the adjustable valve 20.

The fluid from the positive pressure source 30 may be directed into two separate fluid paths 31, 32 wherein a first path 31 is in fluid connection with the inflatable members in the atria 26, 27 and a second path 32 is in fluid connection with the inflatable members in the ventricles 28, 29. As shown, each fluid path 31, 32 has at least one flow sensor 34, 35 communicably connected to a control unit 36 to read a parameter of the fluid flow in the fluid paths 31, 32.

The control unit 36 includes a controller 40 and an information processing device 41. The control unit 36 controls the system 10. The controller 40 includes a first processor 47, a first memory 48 functioning as a storing section, and a first communication section 49. The controller 40 performs communication with the information processing device 41 via the first communication section. These components are communicably connected to one another via a bus (not shown).

The first processor 47 is, for example, a CPU (Central Processing Unit) or may be another processor such as an FPGA (Field Programable Gate Array) instead of the CPU. The first processor 47 executes various programs stored in the first memory 48.

The first memory 48 includes, for example, an HDD (Hard Disk Drive), SSD (Solid State Drive), an EEPROM (Electrically Erasable Programmable Read-Only Memory), a ROM (Read-Only Memory) or a RAM (Random Access Memory). The first memory 48 may be an external storage device connected by, for example, a digital input/output port such as USB instead of a storage device incorporated in the controller 40. The first memory 48 stores various kinds of information, various images, an operation program, and the like to be processed by the controller 40. The first memory 48 may be configured by one storage device or may be configured by a plurality of storage devices.

The first communication section 49 includes a digital input/output port such as USB or Ethernet port. The controller 40 may include one or both of an input device such as a keyboard, a mouse, or a touch pad and a display device including a display.

The controller 40 is communicably connected to the adjustable valve 20 and information processing device 41. The controller 40 is configured to receive input from the information processing device 41 to modify control of the adjustable valve 20.

The Information processing device 41 includes a second processor 55, a second memory 56, a second communication section 57, a first input receiving section 58, and a first display section 59. The information processing device 41 performs communication with the controller 40 via the second communication section 57. These components are communicably coupled to one another via a bus.

The configuration of the second processor 55 is the same as the configuration of the first processor 47. Therefore, explanation of the configuration of the second processor 55 is omitted.

The configuration of the second memory 56 is the same as the configuration of the first memory 48. Therefore, explanation of the configuration of the second memory 56 is omitted.

The configuration of the second communication section 57 is the same as the configuration of the first communication section 49. Therefore, explanation of the configuration of the second communication section 57 is omitted.

The first input receiving section 58 is an input device such as a keyboard, a mouse, or a touch pad. The first input receiving section 58 may be a touch panel configured integrally with the first display section 59.

The first display section 59 is, for example, a liquid crystal display panel or an organic EL (Electro Luminescence) display panel.

The information processing device 41 generates various kinds of information such as an operation program, fluid flow parameter thresholds and adjustable valve 20 mode/position according to operation received from a user, a flow sensor 34, 35 reading, and an environmental sensor 44 reading. The information processing device 41 outputs the generated information to a controller 40 and causes the controller 40 to store the information to thereby, for example, adjust operation of the adjustable valve 20.

The information processing device 41 is communicably connected to the controller 40 by a cable. Wired communication via the cable is performed according to a standard such as Ethernet or USB. Alternatively, the information processing device 41 may be connected to the controller 40 by wireless communication performed according to a communication standard, such as Wi-Fi or Bluetooth® protocols.

The information processing device 41 is communicably connected to receive inputs from the flow sensors 34, 35, the at least one environmental sensor 44 and a BPM (Beats per minute) timer 46 to determine an operation program, fluid flow parameter thresholds and adjustable valve 20 position to communicate to the controller 40 to modify control of the adjustable valve 20.

In one embodiment the environmental sensor 44 is a camera, lidar, radar, or other imaging device capable of imaging the surgical space during use of the system 10. In this embodiment the information processing device 41 is configured to process the resulting image in the second processor 55 and compare it to a training set stored in the second memory 56 to determine if a medical training procedure was successfully completed.

In an additional embodiment the environmental sensor 44 is a button, switch, pedal, or some other analog input that once actuated sends an input to the information processing device 41.

In one embodiment the display section 59 may allow for selection of one of an atrial fibrillation mode, atrial fibrillation mode, sinus mode, tachycardia, bradycardia, or an operating mode designed to reflect a medical procedure. For example, the display section 59 may allow a user to select between an atrial appendage occlusion procedure, a Cox-maze procedure, or the like. In another embodiment, the display section 59 may allow for selection of the body type in which the system is deployed (i.e. synthetic or cadaver).

In one embodiment the display section 59 may allow for selection of operating parameters such as heart rate, a target high pressure in the atria or ventricles, a target low pressure in the atria or ventricles, flow rate, and other parameters relevant to operation of the system.

In one embodiment the control unit 36 may comprise a single processor, a single memory, and a single communication section. The single processor may be configured to execute various programs stored on the single memory to control the adjustable valve 20. The memory may store various kinds of information, various images, an operation program, and the like to be processed by the controller. The control unit 36 may be communicably connected to the flow sensors 34, 35, the environmental sensor 44, and the BPM timer 46 via the single communication section. The single processor may also be communicably connected to the single communication section to receive information to determine an operation program, fluid flow parameter thresholds and adjustable valve 20 position to communicate to modify control of the adjustable valve 20.

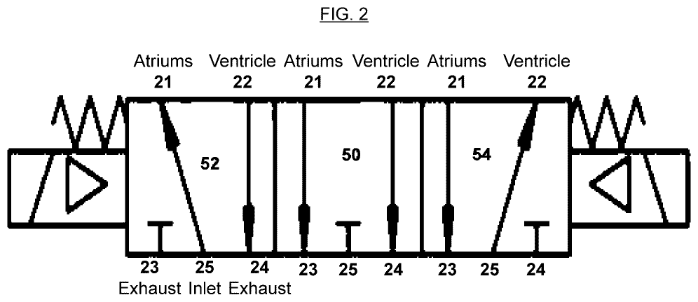

FIG. 2 illustrates a schematic of an embodiment of the adjustable valve 20. The embodiment depicted is a double solenoid valve with three modes of operation (in this example, three positions) and five ports. In a deflate position 50, an outlet 21 is in fluid connection with an exhaust 23, an outlet 22 is in fluid connection with an exhaust 24, and the inlet 25 is not in connection with any other ports. In an atrial inflation position 52, the inlet 25 is in fluid connection with the outlet 21, another outlet 22 is in fluid connection with and exhaust 24 and another exhaust 23 is not in connection with any other ports. In a ventricular inflation position 54, a first inlet 25 is in fluid connection with an outlet 22, another outlet 21 is in fluid connection with an exhaust 23, and another exhaust 24 is not in connection with any other ports. The adjustable valve 20 is typically a four-way, three-position solenoid valve but may be any other suitable adjustable valve with more ways or positions.

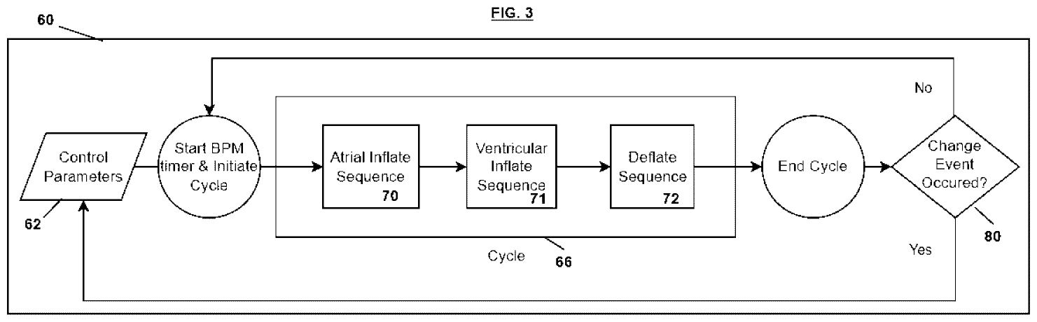

FIG. 3 illustrates a schematic of a method 60 by which the control unit 36 executes an operation program according to at least one input parameter 62 to animate the heart. The input parameter 62 may be received from the display section 59 or from one of the flow sensors 34, 35 or environmental sensors 44. After receiving the input parameter(s) 62, the control unit 36 initiates a heartbeat cycle 66 by starting a BPM timer 46. The heartbeat cycle 66 comprises at least three control sequences performed by the controller 40: an atrial inflation sequence 70, a ventricular inflation sequence 71, and a deflate sequence 72.

After initiating the cycle 66 and starting the BPM timer 46, the controller 40 operates the adjustable valve 20 according to the atrial inflation sequence 70. After the atrial inflation sequence 70 has been completed the controller 40 operates the adjustable valve 20 according to the ventricular inflation sequence 71. Upon completion of the ventricular inflation sequence 71 the controller 40 operates the adjustable valve 20 according to the deflate sequence 72. Once the deflate sequence 72 is terminated, the cycle 66 is over and the information processing device 41 checks for the occurrence of any change event 80. A change event 80 may be, for example, a user input from the display section 59 or signal from the environmental sensor 44. If the information processing device 41 determines that a change event 80 has occurred, the information processing device 41 will inform the controller 40 to reactively adjust the at least one input parameter 62 before performing the next cycle 67 of the sequences 70, 71, 72. If no change event 80 has occurred, the information processing device 41 resets the BPM timer 46 and instructs the controller 40 to initiate the next cycle 67 of sequences 70, 71, 72 according to the same input parameter 62 used in the control of the prior cycle 67.

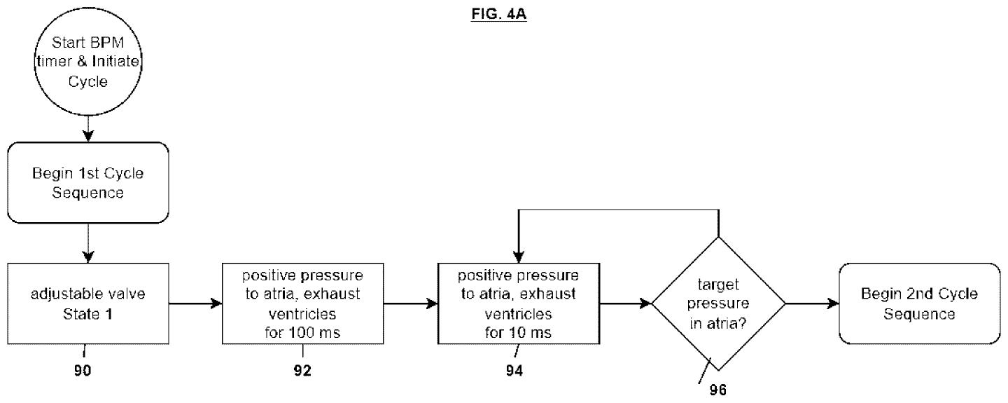

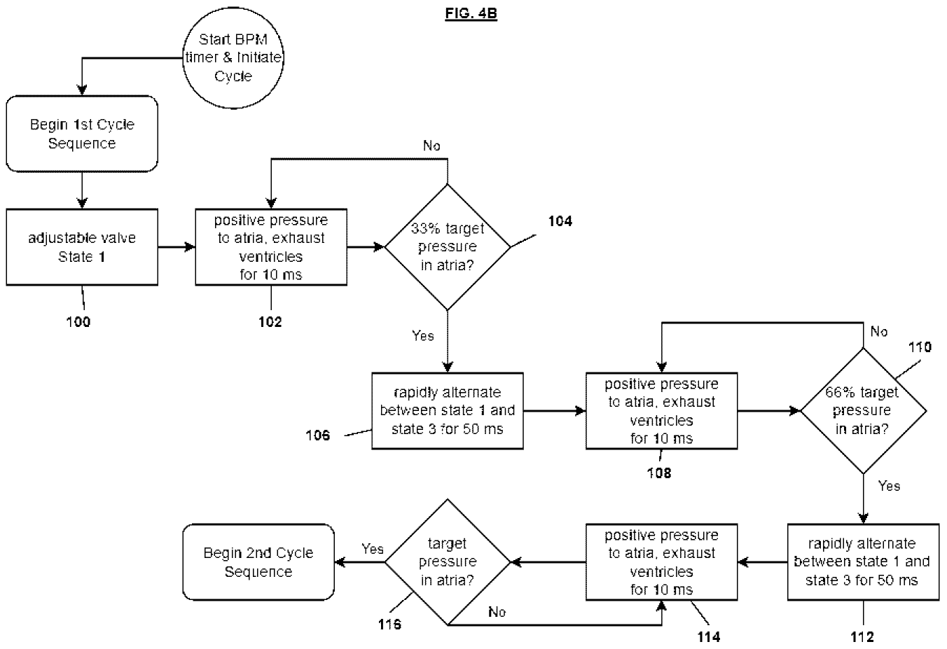

FIGS. 4A and 4B depict a method of controlling the system to perform the atrial inflation sequence 70 in different modes. FIG. 4A depicts the method of controlling the system 10 to perform the atrial inflation sequence 70 for a sinus or ventricular fibrillation mode in steps 90, 92, 94, 96. In a first step 90, the controller 40 begins the atrial inflation sequence 70 by controlling the adjustable valve 20 into an atrial inflation position 52 immediately after the information processing device 41 begins the cycle 66 and starts the BPM timer 46. In a second step 92, the adjustable valve 20 remains in the atrial inflation position 52 for at least 100 milliseconds (ms). In a third step 94, the controller 40 holds the adjustable valve 20 in the atrial inflation position 52 for an additional 10 ms before the information processing device 41 reads the flow sensor 34 on the first fluid path 31 in a fourth step 96. If the flow sensor 34 reading is not at a predetermined threshold, the control unit 36 repeats the third 94 and fourth step 96 until the reading is at the threshold. If the flow sensor 34 reading is at a threshold, the controller 40 will end the atrial inflation sequence 70 and begin the ventricular inflation sequence 71.

In one embodiment of the previously disclosed method of controlling the system 10 to perform the atrial inflation sequence 70 in a sinus or ventricular fibrillation mode, the threshold for the flow sensor 34 reading in the fourth step 96 is a predetermined target high pressure.

FIG. 4B depicts a method of controlling the system 10 to perform the atrial inflation sequence 70 for an atrial fibrillation mode in steps 100, 102, 104, 106, 108, 110, 112, 114, 116. In a first step 100, the controller 40 begins the atrial inflation sequence 70 by controlling the adjustable valve 20 into an atrial inflation position 52 immediately after the information processing device 41 begins the cycle 66 and starts the BPM timer 46.

In a second step 102, the adjustable valve 20 remains in the atrial inflation position 52 for 10 ms before the information processing device 41 reads the flow sensor 34 on the first fluid path 31 in a third step 104. If the flow sensor 34 reading is not at third step threshold, the control unit 36 repeats the second 102 and third step 104 until the reading is at the third step threshold. If the flow sensor 34 reading is at a third step threshold, the controller 40 will rapidly alternate the adjustable valve 20 between the atrial inflation position 52 and the deflate position 50 for 50 ms in the fourth step 106 to create a stuttering or fluttering effect in the atria 26, 27.

In a fifth step 108, the adjustable valve 20 is held at an atrial inflation position 52 for 10 ms before the information processing device 41 reads the flow sensor 34 on the first fluid path 31 in a sixth step 110. If the flow sensor 34 reading is not at sixth step threshold, the control unit 36 repeats the fifth 108 and sixth step 110 until the reading is at the sixth step threshold. If the flow sensor 34 reading is at the sixth step threshold, the controller 40 will rapidly alternate the adjustable valve 20 between the atrial inflation position 52 and the deflate position 50 for 50 ms in the seventh step 112 to create a stuttering or fluttering effect in the atria 26, 27.

In an eighth step 114, the adjustable valve 20 is held at an atrial inflation position 52 for 10 ms before the information processing device 41 reads the flow sensor 34 on the first fluid path 31 in a ninth step 116. If the flow sensor 34 reading is not at ninth step threshold, the control unit 36 repeats the eighth 114 and ninth step 116 until the reading is at the ninth step threshold. If the flow sensor 34 reading is at the ninth step threshold, the controller 40 will end the atrial inflation sequence 70 and begin the ventricular inflation sequence 72.

In another embodiment of the previously disclosed method of controlling the system 10 to perform the atrial inflation sequence 70 in an atrial fibrillation mode, the threshold for the flow sensor 34 reading in the third step 104 may be about 33% of a target high pressure. The threshold for the flow sensor 34 in the sixth step 110 may be about 66% of the target high pressure. Finally, the threshold for the flow sensor 34 reading in the ninth step 116 may be 100% of the target high pressure.

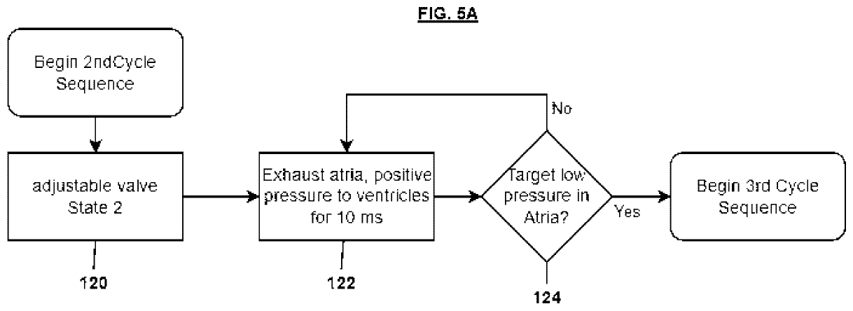

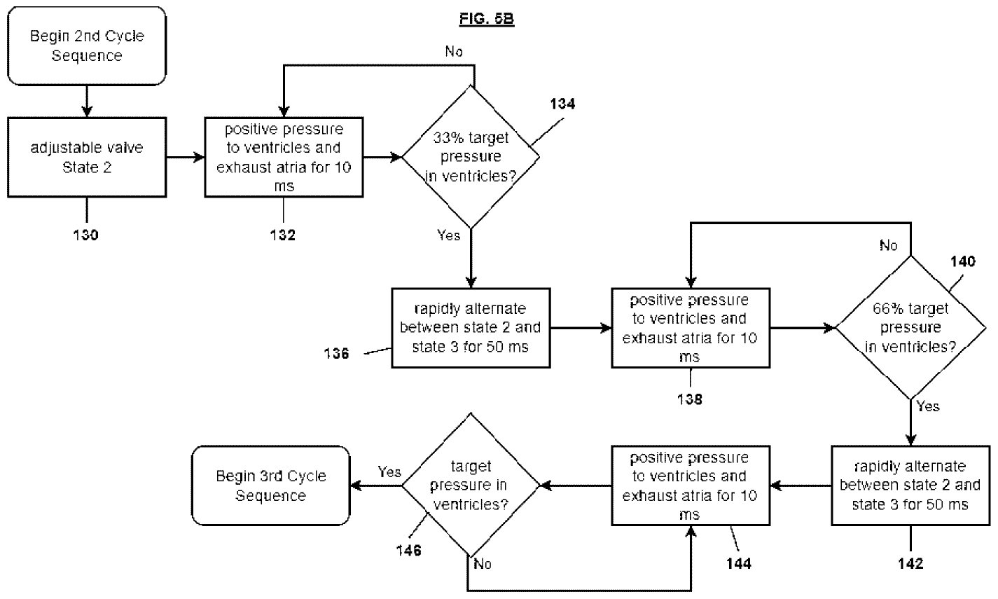

FIGS. 5A and 5B depict a method of controlling the system 10 to perform the ventricular inflation sequence 71 in different modes. FIG. 5A depicts a method of controlling the system to perform the ventricular inflation sequence 71 for a sinus or atrial fibrillation mode in steps 120, 122, 124. In a first step 120, the controller 40 begins the ventricular inflation sequence 71 by controlling the adjustable valve 20 into a ventricular inflation position 54 immediately after the controller 40 ends the atrial inflation sequence 70. In a second step 122, the controller 40 holds the adjustable valve 20 in the ventricular inflation position 54 for 10 ms before it reads the flow sensor 34 on the first fluid path 31 in a third step 124. If the flow sensor 34 reading is not at a threshold, the controller 40 repeats the second 122 and third step 124 until the reading is at the threshold. If the flow sensor 34 reading is at a threshold, the controller 40 will end the ventricular inflation sequence 71 and begin the deflate sequence 72.

In one embodiment of the previously disclosed method of controlling the system 10 to perform the ventricular inflation sequence 70 in a sinus or atrial fibrillation mode, the threshold for the flow sensor 34 reading in the third step 124 is a predetermined target low pressure.

FIG. 5B depicts a method of controlling the system 10 to perform the ventricular inflation sequence 71 for ventricular fibrillation mode in steps 130, 132, 134, 136, 138, 140, 142, 144, 146. In a first step 130, the controller 40 begins the ventricular inflation sequence 71 by controlling the adjustable valve 20 into ventricular inflation position 54 immediately after the controller 40 ends the atrial inflation sequence 70.

In a second step 132, the adjustable valve 20 remains in the ventricular inflation position 54 for 10 ms before the information processing device 41 reads the flow sensor 35 on the second fluid path 32 in a third step 134. If the flow sensor 35 reading is not at the third step threshold, the control unit 36 repeats the second 132 and third step 134 until the reading is at the third step threshold. If the flow sensor 35 reading is at a third step threshold, the controller 40 will rapidly alternate the adjustable valve 20 between the ventricular inflation position 54 and the deflate position 50 for 50 ms in the fourth step 136 to create a stuttering or fluttering effect in the ventricles 28, 29.

In a fifth step 138, the adjustable valve 20 is held at a ventricular inflation position 54 for 10 ms before it reads the flow sensor 35 on the second fluid path 32 in a sixth step 140. If the flow sensor 35 reading is not at sixth step threshold, the control unit 36 repeats the fifth 138 and sixth step 140 until the reading is at the sixth step threshold. If the flow sensor 35 reading is at the sixth step threshold, the controller 40 will rapidly alternate the adjustable valve 20 between the ventricular inflation position 54 and the deflate position 50 for 50 ms in the seventh step 142 to create a stuttering or fluttering effect in the ventricles 28, 29.

In an eighth step 144, the adjustable valve 20 is held at a ventricular inflation position 54 for 10 ms before the information processing device 41 reads the flow sensor 35 on the second fluid path 32 in a ninth step 146. If the flow sensor 35 reading is not at ninth step threshold, the control unit 36 repeats the eighth 144 and ninth step 146 until the reading is at the ninth step threshold 146. If the flow sensor 35 reading is at the ninth step threshold, the controller 40 will end the ventricular inflation sequence 71 and begin the deflate sequence 72.

In one embodiment of the previously disclosed method of controlling the system 10 to perform the ventricular inflation sequence 71 in a ventricular fibrillation mode, the threshold for the flow sensor 35 reading in the third step 134 may be about 33% of a target high pressure. The threshold for the flow sensor 35 in the sixth step 140 may be about 66% of the target high pressure. Finally, the threshold for the flow sensor 34 reading in the ninth step 146 may be 100% of the target high pressure.

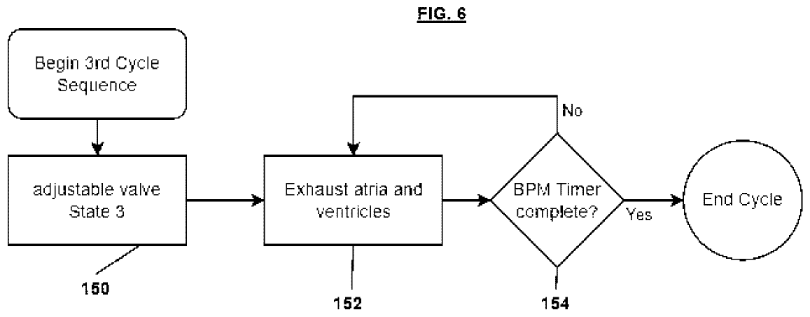

FIG. 6 depicts a method of controlling the system 10 to perform the deflate sequence 72 for a sinus, atrial fibrillation, or ventricular fibrillation mode in steps 150, 152, 154. In a first step 150, the controller 40 begins the deflate sequence 72 by controlling the adjustable valve 20 into the deflate position 50 immediately after the controller 40 ends the ventricular inflation sequence 71. In a second step 152, the adjustable valve 20 remains in the deflate position 50 for at least 10 ms before the information processing device 41 reads the flow sensors 34 on the first fluid path 31 in a third step 154. If the flow sensor 34 reading is not at a threshold, the control unit 36 repeats the second 152 and third step 154 until the reading is at the threshold. If the flow sensor 34 reading is at a threshold, the controller 40 will end the deflate sequence 72 and end the cycle 66.

In one embodiment of the previously disclosed method of controlling the system 10 to perform the deflate sequence 72, the threshold for the flow sensor 34 reading in the third step 124 is a target low pressure.

While one or more embodiments of the present invention have been described in detail, it should be apparent that modifications and variations thereto are possible, all of which fall within the true spirit and scope of the invention. Therefore, the foregoing is intended only to be illustrative of the principles of the invention. Further, since numerous modifications and changes will readily occur to those skilled in the art, it is not intended to limit the invention to the exact construction and operation shown and described. Accordingly, all suitable modifications and equivalents may be included and considered to fall within the scope of the invention, defined by the following claim or claims.

What is claimed is:

1. A system for controlling heart animation of a training model, comprising:
at least one tube assembly comprising:
a first fluid path with at least two inflatable members on one end and a valve connector on the opposite end for connection of the first fluid path to a valve assembly; and
a second fluid path with at least two inflatable members on one end and a valve assembly connector on the opposite end for connection of the second fluid path to the valve assembly;
at least one positive pressure source; and
at least one valve assembly configured to be adjustable to at least three modes and in fluid connection with the first and second fluid paths and the at least one positive pressure source;
wherein a control assembly controls the mode of the valve assembly according to one of a plurality of operating programs stored on a non-transitory computer-readable medium wherein the operating program is selected based on at least one of a plurality of inputs.

2. The system of claim 1, wherein valve mode is determined by valve position.

3. The system of claim 1, wherein inputs include at least one of the group of at least one manual input, at least one flow sensor, and at least one environmental sensor.

4. The system of claim 3, wherein Input parameters may be adjusted during an operation simulation based on an environmental stimulus.

5. The system of claim 4, wherein environmental stimulus includes an input from an environmental sensor.

6. The system of claim 4, wherein the environmental sensor reactively modifies control of the adjustable valve.

7. The system of claim 4, wherein the environmental stimulus includes an input from a user to a control panel.

8. The system of claim 4, wherein the environmental stimulus includes an input from a remote input means or device connected to the controller.

9. The system of claim 1, wherein Input parameters are be adjusted during an operation simulation based on a manual input.

10. The system of claim 1, wherein control of the valve assembly mode controls fluid flow direction.

11. The system of claim 1, wherein control of the valve assembly mode controls fluid flow pressure.

12. A method for controlling heart animation of a training model, the training model comprising at least one tube assembly having at least first and second separate fluid paths where each fluid path has at least two inflatable members, at least one positive pressure source, at least one valve assembly in fluid connection with the at least one first fluid path, the at least one second fluid path, and the at least one positive pressure source, the valve assembly being adjustable to at least three modes, and a control assembly for controlling the position of the valve assembly according to one of a plurality of operating programs, the method comprising:
(a) the control assembly initiating a first operation program wherein the control assembly controls the valve assembly in a first, second and third phase;
(b) looping the first operation program until a change event has occurred;
(c) upon determining that a change event has occurred, the control assembly may automatically modify control of the training model based on a type of the change event.

13. The method of claim 12, wherein a change event occurs upon completion of a simulated heart operation.

14. The method of claim 12, wherein a change event occurs from a manual input.

15. The method of claim 12, wherein a change event is determined by the operating program.

16. The method of claim 12, wherein a change event is determined by stimulus to an environmental sensor.
